(19) United States
(12) Patent Application Publication
(10) Pub. No.: US 2025/0020834 A1
(43) Pub. Date: Jan. 16, 2025

(54) VIEWING ANGLE CONTROL FILM AND DISPLAY APPARATUS

(71) Applicant: Coretronic Corporation, Hsin-Chu (TW)

(72) Inventors: Hsin Huang, Hsin-Chu (TW); Ping-Yen Chen, Hsin-Chu (TW); Ying-Hsiang Chen, Hsin-Chu (TW)

(73) Assignee: Coretronic Corporation, Hsin-Chu (TW)

(21) Appl. No.: 18/755,713

(22) Filed: Jun. 27, 2024

(30) Foreign Application Priority Data
Jul. 11, 2023 (CN) 202310844796.8

(51) Int. Cl. G02B 5/00; G02F 1/13

(52) U.S. Cl. CPC G02B 5/00; G02F 1/1323

(57) ABSTRACT

Disclosed is a viewing angle control film including a transparent substrate and a plurality of first optical microstructures. The first optical microstructures are disposed on a surface of the transparent substrate, and a disposed range thereof has a geometric center. Each of the first optical microstructures has a first refracting surface away from the geometric center. First refracting angles included between the respective first refracting surfaces of the first optical microstructures and the surface of the transparent substrate are asymmetrically distributed with respect to the geometric center. A display apparatus adopting the viewing angle control film is also provided.

### CROSS-REFERENCE TO RELATED APPLICATION

This application claims the priority benefit of China application serial no. 202310844796.8, filed on Jul. 11, 2023. The entirety of the above-mentioned patent application is hereby incorporated by reference herein and made a part of this specification.

### BACKGROUND

### Technical Field

The disclosure relates to a privacy protection display technology, and in particular to a viewing angle control film and a display apparatus.

### Description of Related Art

Generally speaking, a display apparatus usually has a wide viewing angle display effect in order to allow multiple viewers to watch together. However, in certain situations or occasions, such as browsing private web pages, confidential information, or entering passwords in public, the wide viewing angle display effect can easily cause confidential information to be peeped by others, causing confidential information to be leaked.

In order to achieve the privacy protection effect, a common practice is to place a light control film (LCF) in front of the display panel to filter out lights of large angles. Therefore, a good privacy protection effect is bound to be accompanied by a small viewing angle range. However, for monitors with larger display sizes, a narrow viewing angle can easily cause the display brightness of the image to be reduced in the outer areas (such as the left and right sides of the image in the privacy protection direction), thereby the quality of the privacy protection display image is reduced.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

In order to achieve one, part of, or all of the above purposes or other purposes, an embodiment of the disclosure provides a viewing angle control film. The viewing angle control film includes a transparent substrate and multiple first optical microstructures. The first optical microstructures are disposed on a surface of the transparent substrate, and a disposed range thereof has a geometric center. Each of the first optical microstructures has a first refracting surface away from the geometric center. First refracting angles included between the respective first refracting surfaces of the first optical microstructures and the surface of the transparent substrate are asymmetrically distributed with respect to the geometric center.

In order to achieve one, part of, or all of the above purposes or other purposes, an embodiment of the disclosure provides a display apparatus. The display apparatus includes a viewing angle control film and a display panel. The display panel is disposed on a side of the viewing angle control film. The viewing angle control film includes a transparent substrate and multiple first optical microstructures. The first optical microstructures are disposed on a surface of the transparent substrate, and a disposed range thereof has a geometric center. Each of the first optical microstructures has a first refracting surface away from the geometric center. First refracting angles included between the respective first refracting surfaces of the first optical microstructures and the surface of the transparent substrate are asymmetrically distributed with respect to the geometric center.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a display apparatus according to the first embodiment of the disclosure.

FIG. 2 is a schematic perspective view of a viewing angle control film in FIG. 1.

FIG. 3 is a schematic cross-sectional view of the viewing angle control film in FIG. 2.

FIG. 4A is a schematic distribution view of refracting angles at different positions of first optical microstructures in FIG. 3.

FIG. 4B is a schematic distribution view of the refracting angles at different positions of the first optical microstructures in FIG. 4A according to other variation embodiments.

FIG. 5A and FIG. 5B are schematic distribution views of the normalized brightness versus the viewing angle of the viewing angle control film in FIG. 3 at different light emitting positions.

FIG. 6 is a schematic view distribution of the normalized brightness versus different positions on the display screen of the display apparatus in FIG. 1 and a display apparatus according to a comparative example.

FIG. 7 is a schematic perspective view of the viewing angle control film according to another embodiment of the disclosure.

FIG. 8 is a schematic cross-sectional view of the viewing angle control film in FIG. 7.

FIG. 9A is a schematic distribution view of refracting angles at different positions of first optical microstructures in FIG. 8.

FIG. 9B is a schematic distribution view of the refracting angles at different positions of the first optical microstructures in FIG. 9A according to another variation embodiment.

FIG. 10 is a schematic distribution view of the of normalized brightness versus different positions on the display screen of a display apparatus adopting the viewing angle control film in FIG. 8, another display apparatus adopting the two viewing angle control films in FIG. 12A, and a display apparatus according to a comparative example.

FIG. 11 is a schematic view of a display apparatus according to the second embodiment of the disclosure.

FIG. 12A and FIG. 12B are enlarged schematic views of two viewing angle control films in FIG. 11 in different directions.

FIG. 13 is a schematic distribution view of refracting angles at different positions of the respective first optical microstructures of the two viewing angle control films in FIG. 12A and FIG. 12B.

FIG. 14 is a schematic perspective view of a viewing angle control film according to still another embodiment of the disclosure.

FIG. 15A and FIG. 15B are schematic cross-sectional views of the viewing angle control film in FIG. 14 in different directions.

FIG. 16 is a schematic cross-sectional view of the viewing angle control film in FIG. 8 according to another variation embodiment.

FIG. 17A and FIG. 17B are schematic top views of the viewing angle control film in FIG. 7 according to other variation embodiments.

FIG. 18 is a schematic view of a display apparatus according to the third embodiment of the disclosure.

FIG. 19 is a schematic view of a display apparatus according to the fourth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

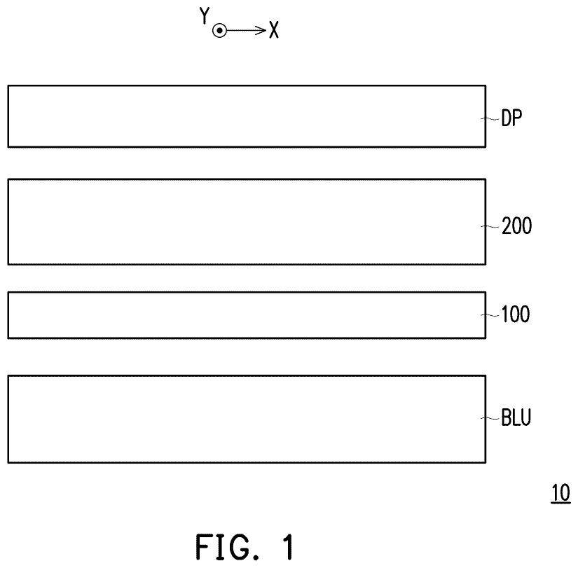

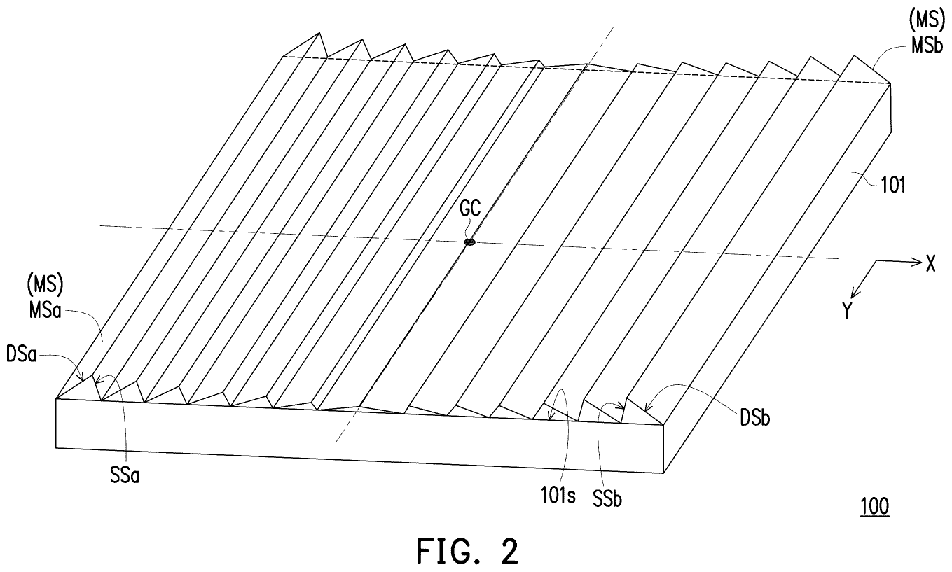

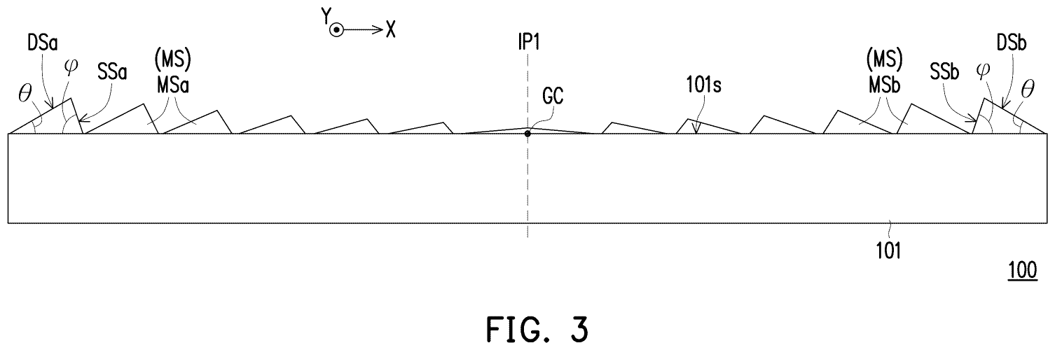

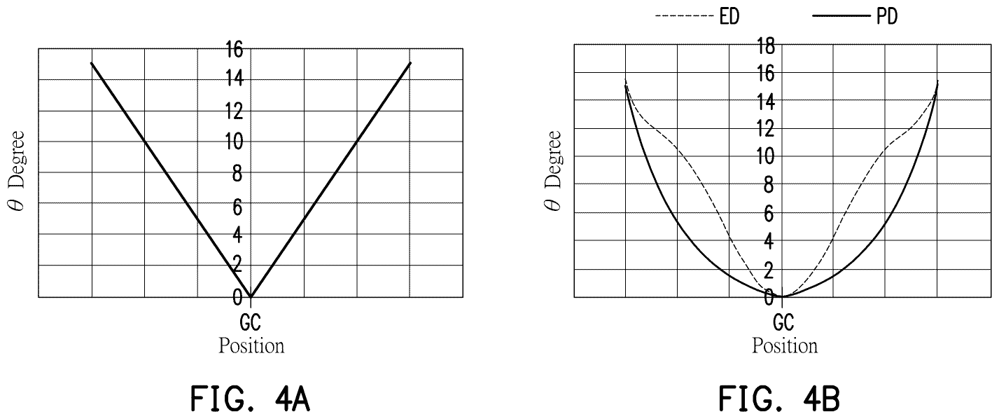

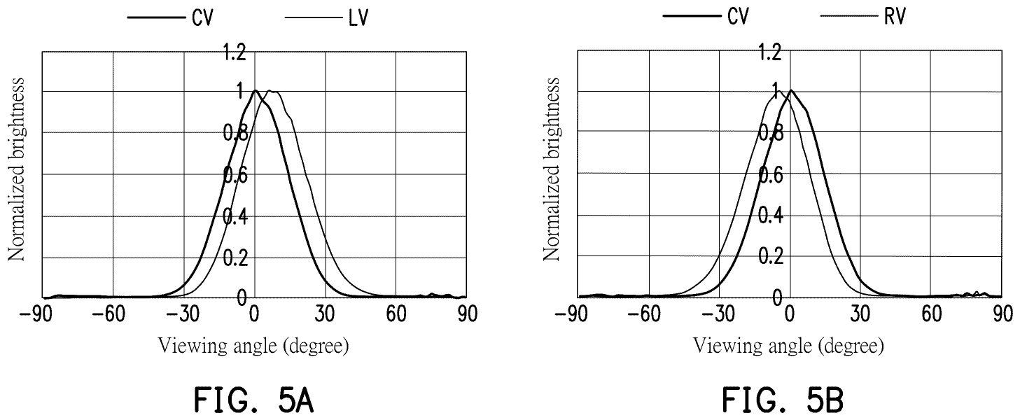

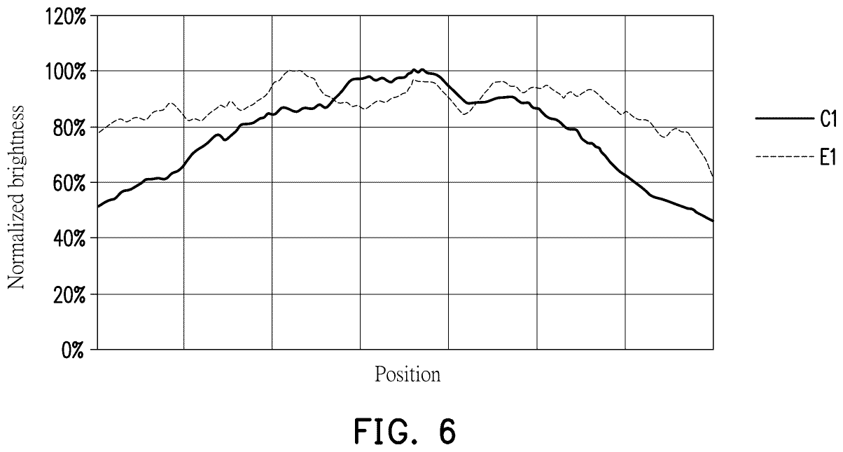

FIG. 1 is a schematic view of a display apparatus according to the first embodiment of the disclosure. FIG. 2 is a schematic perspective view of a viewing angle control film in FIG. 1. FIG. 3 is a schematic cross-sectional view of the viewing angle control film in FIG. 2. FIG. 4A is a schematic distribution view of refracting angles at different positions of first optical microstructures in FIG. 3. FIG. 4B is a schematic distribution view of the refracting angles at different positions of the first optical microstructures in FIG. 4A according to other variation embodiments. FIG. 5A and FIG. 5B are schematic distribution views of the normalized brightness versus the viewing angle of the viewing angle control film in FIG. 3 at different light emitting positions. FIG. 6 is a schematic distribution view of the normalized brightness versus different positions on the display screen of the display apparatus in FIG. 1 and a display apparatus according to a comparative example.

Referring to FIG. 1, a display apparatus 10 includes a viewing angle control film 100, an electrically controlled viewing angle switcher 200, and a display panel DP. The display panel DP is disposed on a side of the viewing angle control film 100. The electrically controlled viewing angle switcher 200 overlaps the viewing angle control film 100 and the display panel DP.

In this embodiment, the display panel DP may be a non-self-luminous display panel (such as a liquid crystal display panel, but not limited thereto). Correspondingly, the display apparatus 10 may also be provided with a backlight module BLU to serve as an illumination light source for the non-self-luminous display panel, in which the backlight module BLU may be a side-type backlight module (such as a combination of a light guide plate and a side-type light source) or a direct-type backlight module (such as a light-emitting diode panel or an array of light bars). However, the disclosure is not limited thereto. In other embodiments, the display panel DP may also be a self-luminous display panel, and the viewing angle control film 100 is disposed on a side of the display surface of the display panel DP (for example, the upper side of the display panel DP in FIG. 1).

In this embodiment, the electrically controlled viewing angle switcher 200 may be selectively disposed between the display panel DP and the backlight module BLU, but not limited thereto. In other embodiments, the electrically controlled viewing angle switcher 200 may also be disposed on a side of the display panel DP away from the backlight module BLU. For example, the electrically controlled viewing angle switcher 200 may be an electrically controlled liquid crystal cell with the polarization modulation capability, an electrophoretic electrically controlled privacy protection film, or an electrically controlled privacy protection film with the photochromic property, and not limited thereto.

Please refer to FIG. 2 and FIG. 3. In detail, the viewing angle control film 100 includes a transparent substrate 101 and multiple optical microstructures MS. In this embodiment, the multiple optical microstructures MS are disposed on a surface 101s of the transparent substrate 101, and the multiple optical microstructures MS may be arranged along a direction X and extend in a direction Y, in which the direction X intersects (e.g., perpendicularly) with the direction Y. For example, in this embodiment, the optical microstructures MS of the viewing angle control film 100 may be disposed away from the backlight module BLU, but not limited thereto. In other embodiments, the optical microstructures MS may be disposed toward the backlight module BLU.

It should be noted that, a disposed range of the multiple optical microstructures MS on the transparent substrate 101 has a geometric center GC, and the optical microstructures MS include multiple optical microstructures MSa disposed on a side of the geometric center GC (for example, the left side of the geometric center GC in FIG. 2) and multiple optical microstructures MSb disposed on another side of the geometric center GC (for example, the right side of the geometric center GC in FIG. 2).

For example, in this embodiment, the distribution range of each optical microstructure MSa positioned on the side of the geometric center GC and one of the multiple optical microstructures MSb positioned on the another side of the geometric center GC are symmetrically disposed with respect to the geometric center GC. That is, the number of the optical microstructures MSa positioned on the side of the geometric center GC may be equal to the number of the optical microstructures MSb positioned on the another side of the geometric center GC, and the symmetrical relationship between the multiple optical microstructures MSa and the multiple optical microstructures MSb is one to one. However, the disclosure is not limited thereto. In other embodiments not shown, the number of the optical microstructures MSa positioned on the side of the geometric center GC may be different from the number of the optical microstructures MSb positioned on the another side of the geometric center GC.

To be clearer, the symmetrical relationship between the multiple optical microstructures MSa and the multiple optical microstructures MSb according to this embodiment is with respect to a virtual plane IP1, in which the virtual plane IP1 passes through the geometric center GC and is perpendicular to the direction X. Since the multiple optical microstructures MS of this embodiment extend in the direction Y, the optical microstructures MS are also respectively symmetrically disposed with respect to another virtual plane (not shown), and the another virtual plane passes through the geometric center GC and is perpendicular to the direction Y.

Furthermore, each of the plurality of optical microstructures MSa has a refracting surface DSa away from the geometric center GC, and each of the plurality of optical microstructure MSb has a refracting surface DSb away from the geometric center GC. That is, the optical microstructures MSa and the optical microstructures MSb positioned on opposite sides of the geometric center GC respectively have the refracting surfaces DSa and the refracting surface DSb that are away from each other.

In this embodiment, angles of the refracting angles included between the respective refracting surfaces of the multiple optical microstructure MS and the surface 101s of the transparent substrate 101 are symmetrically distributed with respect to the geometric center GC. More specifically, the two optical microstructures MSa and MSb are respectively disposed on opposite sides of the geometric center GC, and distribution ranges of the two optical microstructures MSa and MSb are symmetrically disposed with respect to the geometric center GC (that is, equidistantly disposed with respect to the geometric center GC). Angles of the refracting angles included between the refracting surfaces of the two optical microstructures MSa and MSb and the surface 101s of the transparent substrate 101 may be selectively the same. For example, the refracting surface DSa of the optical microstructure MSa to the left of the geometric center GC and farthest away from the geometric center GC and the refracting surface DSb of the optical microstructure MSb to the right of the geometric center GC and farthest away from the geometric center GC have the same refracting angle θ, and so on.

Please refer to FIG. 3 and FIG. 4A. The refracting angle θ of the optical microstructure MS gradually decreases as the distribution position thereof approaching the geometric center GC. For example, in this embodiment, the distribution of the refracting angle θ of the optical microstructure MS versus the position is presented as a linear relationship, as shown in FIG. 4A, but not limited thereto. In other embodiments, the distribution of the refracting angle θ of the optical microstructure MS versus the position may also be presented as an exponential relationship (as shown in Curve PD in FIG. 4B) or a polynomial relationship (shown in Curve ED in FIG. 4B).

On the other hand, each of the plurality of optical microstructures MSa also has a structural surface SSa facing the geometric center GC, and each of the plurality of optical microstructures MSb also has a structural surface SSb facing the geometric center GC. That is, the optical microstructure MSa and optical microstructure MSb positioned on opposite sides of the geometric center GC have the structural surface SSa and the structural surface SSb facing each other respectively. Angles of structural angles included between the respective structural surfaces of the multiple optical microstructures MS and the surface 101s of the transparent substrate 101 may be greater than or equal to the refracting angle θ.

In this embodiment, the structural angles included between the respective structural surfaces of the multiple optical microstructures MS and the surface 101s of the transparent substrate 101 are symmetrically distributed with respect to the geometric center GC. More specifically, the two optical microstructures MSa and MSb are disposed on opposite sides of the geometric center GC, and distribution ranges of the two optical microstructures MSa and MSb are symmetrically disposed with respect to the geometric center GC (that is, equidistantly disposed with respect to the geometric center GC). Angles of the structural angles included between the respective structural surfaces of the two optical microstructures MSa and MSb and the surfaces 101s of the transparent substrate 101 may be selectively the same. For example, the structural surface SSa of the optical microstructure MSa to the left of the geometric center GC and farthest away from the geometric center GC and the structural surface SSb of the optical microstructure MSb to the right of the geometric center GC and farthest away from the geometric center GC have the same structural angle φ, and so on.

In this embodiment, the structural angle φ of the optical microstructure MS gradually decreases as the distribution position thereof approaching the geometric center GC, but not limited thereto. In other embodiments, the respective structural angles φ of the multiple optical microstructures MS may also be the same as each other, that is, the structural angles φ of the optical microstructures MS do not differ with the disposed positions thereof.

FIG. 5A and FIG. 5B show distribution plots of normalized brightness versus viewing angle respectively obtained at the center and the leftmost and rightmost light emission positions parallel to direction X of the display apparatus 10 in FIG. 1. Referring to FIG. 3 and FIG. 5A, for example, when the light (not shown) is incident on the optical microstructure MSa of the viewing angle control film 100 positioned on the left side of the geometric center GC in a manner from the lower side or upper side of the viewing angle control film 100 forward to the surface 101s of the transparent substrate 101, the refracting surface DSa of the optical microstructure MSa on the left side of the geometric center GC can deflect the light toward the center of the viewing angle control film 100 (that is, deflect to the right). Therefore, for the light passing through the optical microstructure MSa positioned on the left side of the geometric center GC, the center viewing angle of the light distribution deviates to the right with respect to the position of the viewing angle 0 degree (as shown by Curve LV in FIG. 5A). Since the optical microstructure MS closest to the geometric center GC has the refracting angle θ that is the smallest and the closest to 0 degree, the center viewing angle of the light distribution after the light passes through does not shift significantly with respect to the position of the viewing angle 0 degree (as shown by Curve CV in FIG. 5A).

Please refer to FIG. 3 and FIG. 5B. Similarly, when the light is incident on the optical microstructure MSb of the viewing angle control film 100 positioned on the right side of the geometric center GC in a manner from the lower or upper side of the viewing angle control film 100 forward to the surface 101s of the transparent substrate 101, the refracting surface DSb of the optical microstructure MSb on the right side of the geometric center GC can deflect the light toward the center of the viewing angle control film 100 (that is, deflect to the left). Therefore, for the light passing through the optical microstructure MSb positioned on the right side of the geometric center GC, the center viewing angle of the light distribution deviates to the left with respect to the position of the viewing angle 0 degree (as shown by Curve RV in FIG. 5B).

More specifically, the optical microstructure MSa and the optical microstructure MSb are disposed on opposite sides of the geometric center GC, so that the light passing through the viewing angle control film 100 at different positions from the geometric center GC may be guided to a specific light-collecting position (for example, by a position at the optical axis passing through the geometric center GC and axially perpendicular to the surface 101s of the transparent substrate 101). Therefore, the overall light emission uniformity of the viewing angle control film 100 for a specific or single light-collecting position can be effectively improved.

Curve E1 in FIG. 6 is a distribution curve of the normalized brightness measured at a position facing the display center of the display apparatus 10 of this embodiment versus different positions on the display screen, while Curve C1 is a distribution curve of the normalized brightness measured at a position facing the display center of the display apparatus of a comparative example versus different positions on the display screen. The display apparatus of the comparative example is similar to the display apparatus 10 of this embodiment except for not being disposed with the viewing angle control film 100 of this embodiment. The normalized brightness in the drawing is the percentage value of the brightness measured at each position on the display apparatus versus the maximum brightness measured at the positions.

As may be seen from FIG. 6, the light emission brightness of the display apparatus 10 of this embodiment in the area deviated from the display center is significantly higher than the display apparatus of the comparative example, and the overall light emission uniformity is also better. In other words, since the display apparatus 10 of this embodiment is disposed with the viewing angle control film 100, the display screen can have a good brightness uniformity for a specific viewing position.

Another embodiment will be listed below to describe the disclosure in detail, in which the same components will be marked with the same reference numerals, and the description of the same technical content will be omitted. For the omitted parts, reference may be made to the aforementioned embodiment, and will not be repeated.

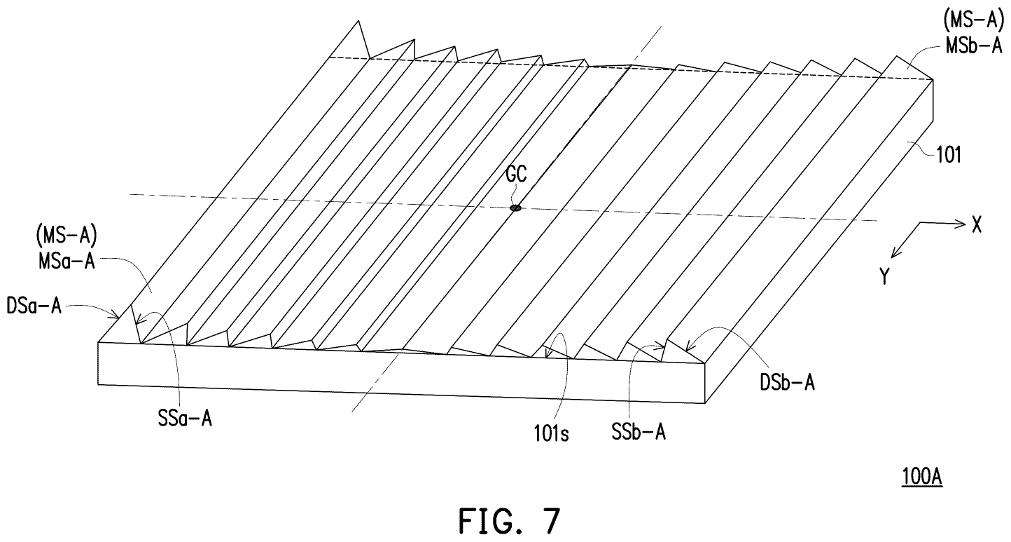

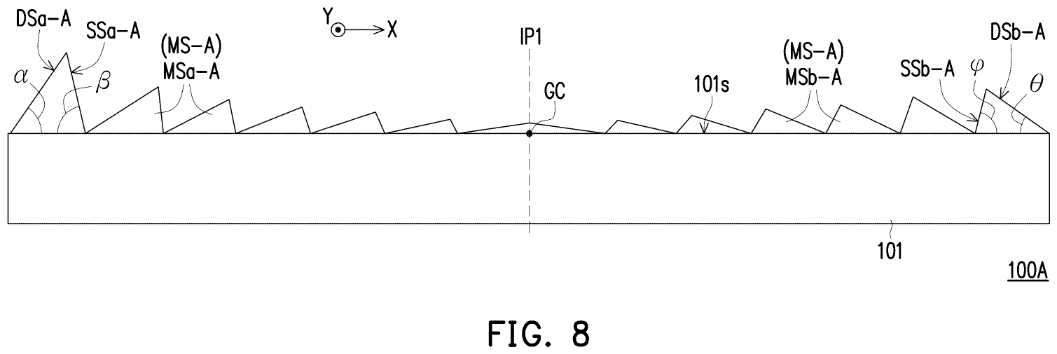

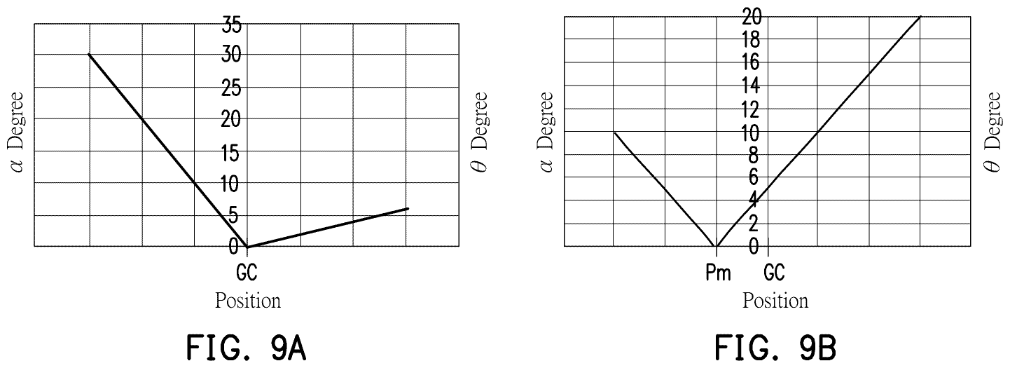

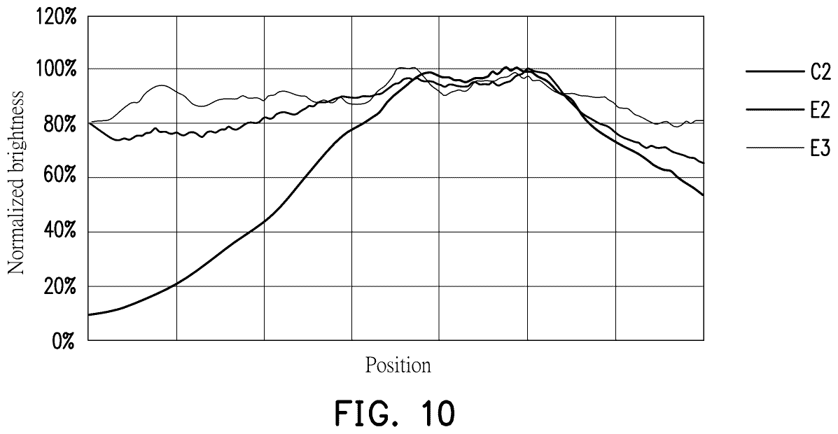

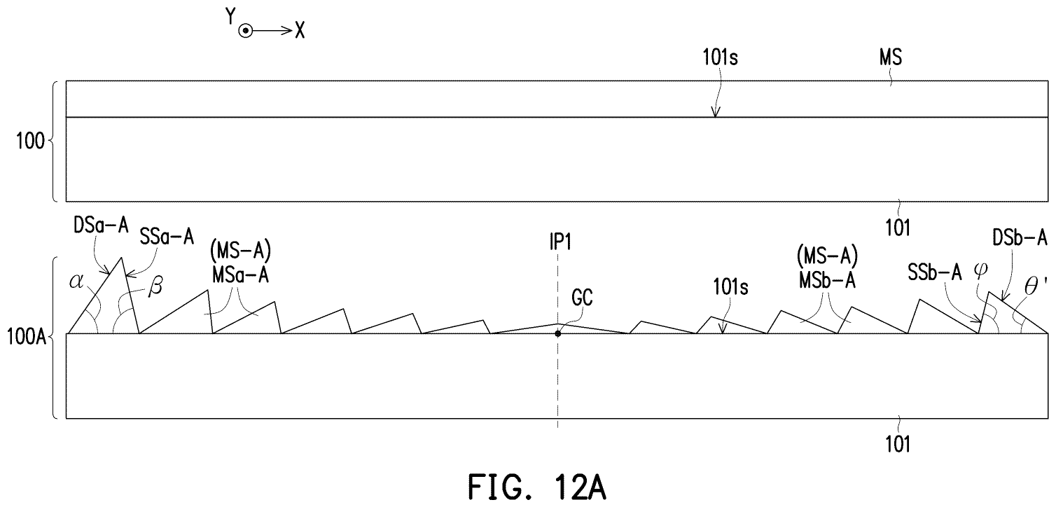

FIG. 7 is a schematic perspective view of the viewing angle control film according to another embodiment of the disclosure. FIG. 8 is a schematic cross-sectional view of the viewing angle control film in FIG. 7. FIG. 9A is a schematic distribution view of refracting angles at different positions of first optical microstructures in FIG. 8. FIG. 9B is a schematic distribution view of the refracting angles at different positions of the first optical microstructures in FIG. 9A according to another variation embodiment. FIG. 10 is a schematic distribution view of the normalized brightness versus different positions on the display screen of a display apparatus adopting the viewing angle control film in FIG. 8, another display apparatus adopting the two viewing angle control films in FIG. 12A, and a display apparatus according to a comparative example.

Please refer to FIG. 7 and FIG. 8. Different from the viewing angle control film 100 in FIG. 2 and FIG. 3, the refracting angles included between the refracting surfaces of the optical microstructures MS-A and the surface 101s of the transparent substrate 101 of a viewing angle control film 100A according to this embodiment are asymmetrically distributed with respect to the geometric center GC.

More specifically, the two optical microstructures MSa-A and MSb-A respectively disposed on opposite sides of the geometric center GC, and distribution ranges of the two optical microstructures MSa-A and MSb-A are symmetrically disposed with respect to the geometric center GC (that is, equidistantly disposed with respect to the geometric center GC). Angles of the refracting angles between the refracting surfaces of the two optical microstructures MSa-A and MSb-A and the surface 101s of the transparent substrate 101 may be selectively different. For example, an angle of a refracting angle α of a refracting surface DSa-A of the optical microstructure MSa-A on the left side of the geometric center GC and farthest from the geometric center GC may be greater than an angle of a refracting angle θ of a refracting surface DSb-A of the optical microstructure MSb-A on the right side of the geometric center GC and farthest from the geometric center GC, and so on.

Please refer to FIG. 8 and FIG. 9A. The refracting angle α of the optical microstructure MSa-A and the refracting angle θ of the optical microstructure MSb-A both gradually decrease as the distribution positions thereof approaching the geometric center GC. For example, in this embodiment, the respective distributions of the refracting angle α of the optical microstructure MSa-A and the refracting angle θ of the optical microstructure MSb-A versus the position are presented as linear relationships, as shown in FIG. 9A.

It should be noted that, although the distribution of the refracting angle of the optical microstructure MS-A versus the position according to this embodiment is also similar to the linear relationship of the viewing angle control film 100 in FIG. 3 and FIG. 4A, the slope of the linear relationship of the refracting angle α of the optical microstructure MSa-A positioned on the left side of the geometric center GC versus the position may be greater than the slope of the linear relationship of the refracting angle θ of the optical microstructure MSb-A positioned on the right side of the geometric center GC versus the position. That is, the linear relationship of the refracting angle α of the optical microstructure MSa-A versus the position and the linear relationship of the refracting angle θ of the optical microstructure MSb-A versus the position may be asymmetrically distributed with respect to the position of the geometric center GC.

However, the disclosure is not limited thereto. In another embodiment, although the distribution relationship of each refracting angle of the multiple optical microstructures versus the position is also presented as the asymmetric distribution with respect to the position of the geometric center GC, the distribution of the angles of the refracting angles of the optical microstructures has a minimum value at a position Pm, and the position Pm may not overlap or deviate from the geometric center GC (as shown in FIG. 9B). That is, the angles of the refracting angles of the optical microstructures gradually decrease as approaching the position Pm.

On the other hand, in this embodiment, structural angles β between respective structural surfaces SSa-A of the multiple optical microstructures MSa-A and the surface 101s of the transparent substrate 101 may be equal to or different from the structural angles φ between the respective structural surfaces SSb-A of the multiple optical microstructures MSb-A and the surface 101s of the transparent substrate 101. An angle of the structural angle between the structural surface of each optical microstructure MS-A and the surface 101s of the transparent substrate 101 may be greater than or equal to an angle of the refracting angle thereof.

In this embodiment, the structural angles β of the optical microstructures MSa-A gradually decrease as the distribution position thereof approaching the geometric center GC, and the structural angles q of the optical microstructures MSb-A gradually decrease as the distribution position thereof approaching the geometric center GC, but not limited thereto. In other embodiments, the respective structural angles β of the plurality of optical microstructures MSa-A may be the same as each other, and the respective structural angles φ of the plurality of optical microstructures MSb-A may be the same as each other. That is, the structural angle β of the optical microstructure MSa-A does not vary with the disposed position thereof, and the structural angle φ of the optical microstructure MSb-A does not vary with the disposed position thereof.

It should be noted that, the optical microstructure MSa-A and the optical microstructure MSb-A are disposed asymmetrically on opposite sides of the geometric center GC, so that the light passing through the viewing angle control film 100A at different positions from the geometric center GC may be guided to a specific light-collecting position, and the specific light-collecting position is, for example, a position at the right side of the optical axis passing through the geometric center GC and axially perpendicular to the surface 101s of the transparent substrate 101. Therefore, the overall light emission uniformity of the viewing angle control film 100A for the specific or single light-collecting position can be effectively improved.

More specifically, the viewing angle control film 100A of this embodiment may be applied to a display apparatus with a single-sided privacy protection function, such as a car display, but not limited thereto. For example, in order to avoid vehicle monitors from interfering with driving when driving at night, such vehicle monitors may be operated in a privacy protection mode (that is, a mode in which only passengers in the front passenger seat and the back seat can view the display). Applying the viewing angle control film 100A of this embodiment to this type of display apparatus can greatly reduce the problem of the display screen being dark on the privacy protection side.

Curve C2 in FIG. 10 is a distribution curve of the normalized brightness measured at a position facing the display center of the display apparatus of the comparative example versus different positions on the display screen (such as the display apparatus with the single-sided privacy protection function), while Curve E2 is a distribution curve of the normalized brightness measured at a position facing the display center of the display apparatus of this embodiment versus different positions on the display screen. It should be noted that, the display apparatus of this embodiment is, for example, a combination of the display apparatus of the comparative example and the viewing angle control film 100A. The normalized brightness in the drawing is the percentage value of the brightness measured at each position on the display apparatus versus the maximum brightness measured at the positions.

As may be seen from FIG. 10, the light emission brightness of the display apparatus of this embodiment in the area deviated from the display center (such as the left area in FIG. 10, that is, the privacy protection side) is significantly higher than the display apparatus of the comparative example, and the overall light emission uniformity is also better. In other words, since the display apparatus of this embodiment is disposed with the viewing angle control film 100A, the display screen can have a good brightness uniformity for a specific viewing position (such as the front passenger seat or the back seat of the car).

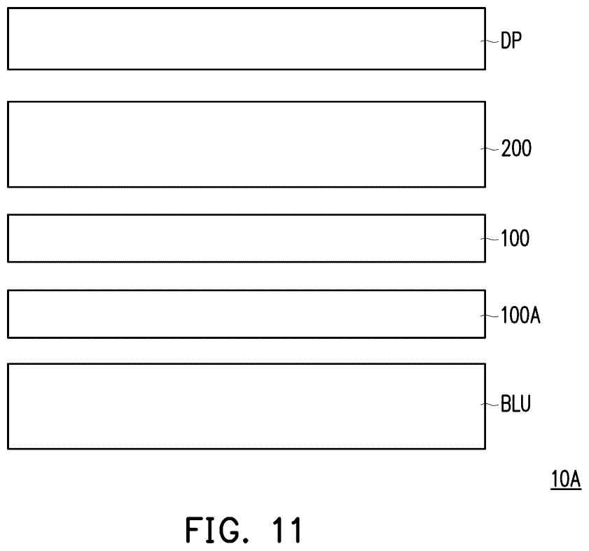

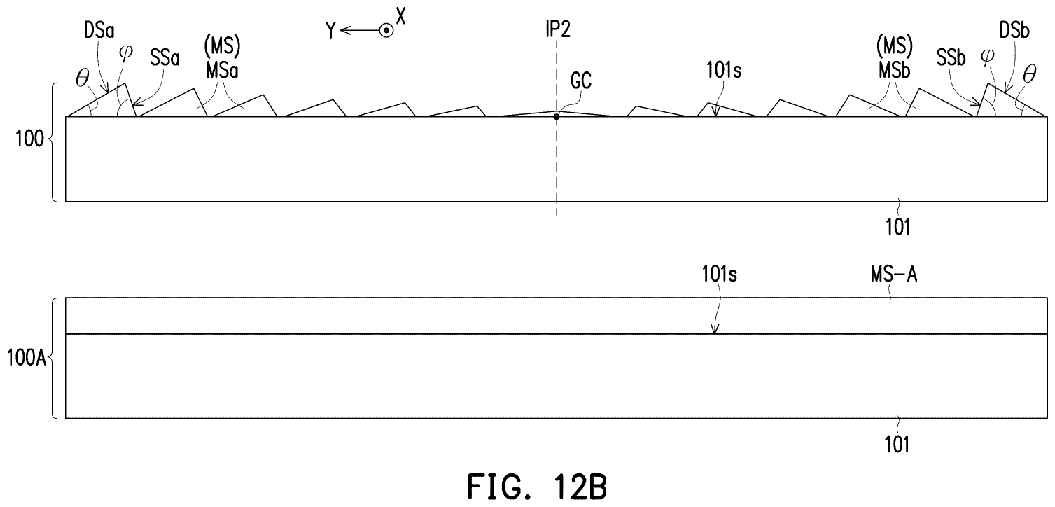

FIG. 11 is a schematic view of a display apparatus according to the second embodiment of the disclosure. FIG. 12A and FIG. 12B are enlarged schematic views of two viewing angle control films in FIG. 11 in different directions. FIG. 13 is a schematic distribution view of refracting angles at different positions of the respective first optical microstructures of the two viewing angle control films in FIG. 12A and FIG. 12B.

Please refer to FIG. 11, FIG. 12A, and FIG. 12B. Different from the display apparatus 10 in FIG. 1, a display apparatus 10A of this embodiment may include two viewing angle control films, such as the viewing angle control film 100 in FIG. 3 and the viewing angle control film 100A in FIG. 8. It should be noted that, in this embodiment, an angle of the refracting angle θ of the viewing angle control film 100 may be different from an angle of a refracting angle θ′ and an angle of the refracting angle α of the viewing angle control film 100A. Therefore, the refracting angle of the optical microstructure MSb-A of the viewing angle control film 100A in this embodiment is marked with θ′ to be distinguished from the refracting angle θ of the optical microstructure MSb of the viewing angle control film 100.

In this embodiment, the viewing angle control film 100A may be positioned between the viewing angle control film 100 and the backlight module BLU, but not limited thereto. In other embodiments, the viewing angle control film 100A may also be disposed between the viewing angle control film 100 and the electrically controlled viewing angle switcher 200, or on the side of the display panel DP away from the backlight module BLU.

It should be noted, that in this embodiment, an extending direction of the optical microstructure MS of the viewing angle control film 100 intersects with an extending direction of the optical microstructure MS-A of the viewing angle control film 100A. For example, the multiple optical microstructures MS of the viewing angle control film 100 may be arranged along the direction Y and extend in the direction X, and the multiple optical microstructures MS-A of the viewing angle control film 100A may be arranged along the direction X and extend in the direction Y (as shown in FIG. 12A and FIG. 12B), but not limited thereto, the multiple optical microstructures MS may also be arranged along the direction X and extend in the direction Y, and the multiple optical microstructures MS-A of the viewing angle control film 100A may be arranged along the direction Y and extend in the direction X. That is, the extending directions of the optical microstructures of the two viewing angle control films may be perpendicular to each other.

From another point of view, the multiple optical microstructures MSa-A and the multiple optical microstructures MSb-A of the viewing angle control film 100A are asymmetrically disposed with respect to the virtual plane IP1, while the multiple optical microstructures MSa and the multiple optical microstructures MSb of the viewing angle control film 100 are symmetrically disposed with respect to a virtual plane IP2, in which the virtual plane IP1 passes through the geometric center GC of the viewing angle control film 100A and is perpendicular to the direction X, and the virtual plane IP2 passes through the geometric center GC of the viewing angle control film 100 and is perpendicular to the direction Y.

Since the viewing angle control film 100 and the viewing angle control film 100A of this embodiment are respectively similar to the viewing angle control film 100 in FIG. 3 and the viewing angle control film 100A in FIG. 8, for detailed description, reference may be made to the relevant paragraphs corresponding to the embodiment mentioned above, and details will not be repeated here.

FIG. 13 shows the distribution relationship of the angle of the refracting angle (for example, the refracting angle α of the optical microstructure MSa-A and the refracting angle θ′ of the optical microstructure MSb-A) of the optical microstructure MS-A of the viewing angle control film 100A along the direction X versus different positions and the distribution relationship of the angle of the refracting angle (for example, the refracting angle θ of the optical microstructure MSa and the refracting angle θ of the optical microstructure MSb) of the optical microstructure MS of the viewing angle control film 100 along the direction Y versus different positions.

More specifically, angles of the refracting angles included between the respective refracting surfaces of the multiple optical microstructures MS of the viewing angle control film 100 and the surface 101s of the transparent substrate 101 are symmetrically distributed along the direction Y with respect to the geometric center GC (as shown in FIG. 12B), and angles of the refracting angles included between the refracting surfaces of the optical microstructures MS-A of the viewing angle control film 100A and the surface 101s of the transparent substrate 101 are asymmetrically distributed along the direction X with respect to the geometric center GC (as shown in FIG. 12A).

Curve E3 in FIG. 10 is a distribution curve of the normalized brightness measured at a position facing the display center of the display apparatus 10A of this embodiment versus different positions on the display screen. The display apparatus 10A of this embodiment is not only disposed with the viewing angle control film 100A that can guide light to a specific position at different positions in the direction X, but is also disposed with the viewing angle control film 100 that can guide light to a specific position at different positions in the direction Y. Therefore, compared with the performance of the display apparatus merely adopting the viewing angle control film 100A (as shown in Curve E2 in FIG. 10), the overall brightness uniformity of the display screen of the display apparatus 10A can be further improved at the specific position (as shown in Curve E3 in FIG. 10).

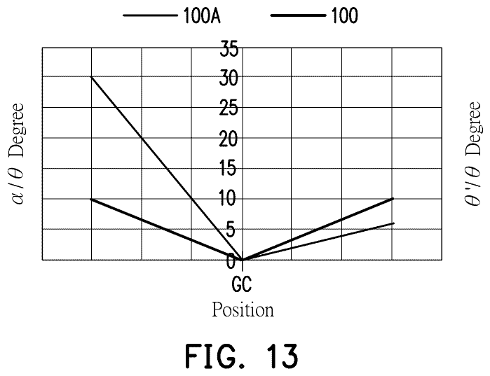

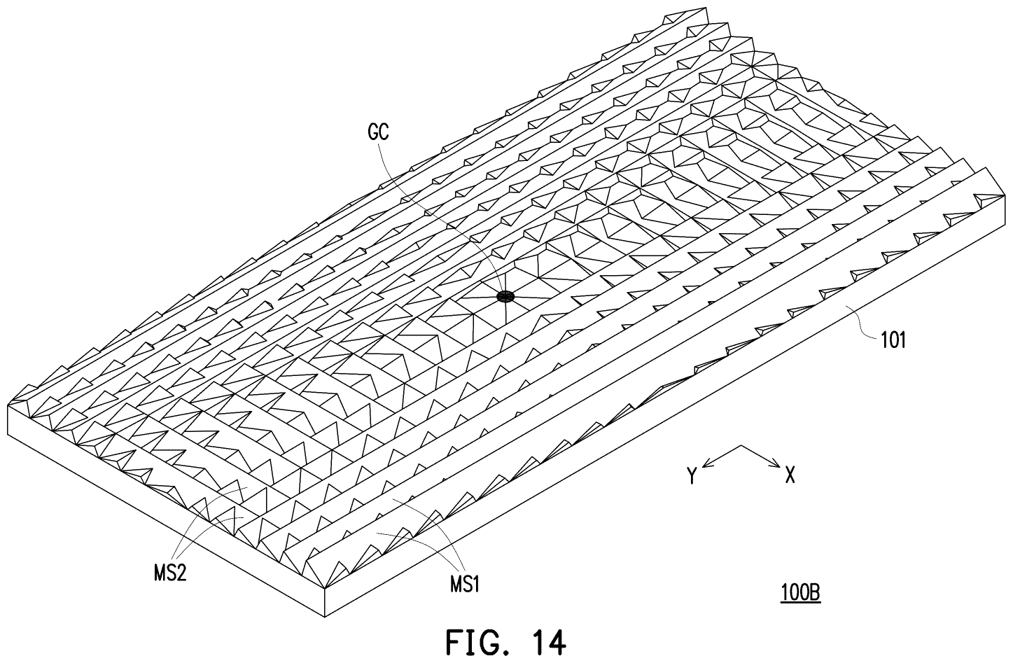

FIG. 14 is a schematic perspective view of a viewing angle control film according to still another embodiment of the disclosure. FIG. 15A and FIG. 15B are schematic cross-sectional views of the viewing angle control film in FIG. 14 in different directions. Please refer to FIG. 14, FIG. 15A, and FIG. 15B. Different from the two viewing angle control films 100 and 100A adopted in the display apparatus 10A in FIG. 11, which are structurally separated from each other, in this embodiment, a viewing angle control film 100B has the refractive power in the direction X and the direction Y at the same time.

For example, in this embodiment, a viewing angle control film 100B includes a plurality of first optical microstructures MS1 and a plurality of second optical microstructures MS2, and the first optical microstructures MS1 and the second optical microstructures MS2 are all disposed on the surface 101s of the transparent substrate 101. More specifically, the disposed range of the first optical microstructures MS1 overlaps the disposed range of the second optical microstructures MS2, and the extending direction (such as the direction Y) of the first optical microstructures MS1 intersects the extending direction (such as the direction X) of the second optical microstructures MS2.

In the viewing angle control film 100B of this embodiment, angles of the respective refracting angles (i.e., the first refracting angles) of the plurality of first optical microstructures MS1 are asymmetrically distributed along the direction X with respect to the geometric center GC or the virtual plane IP1 passing through the geometric center GC, and angles of the respective refracting angles (i.e. the second refracting angles) of the plurality of second optical microstructures MS2 are symmetrically distributed along the direction Y with respect to the geometric center GC or the virtual plane IP2 passing through the geometric center GC. For example, in the direction X, an angle of a refracting angle α1 between a refracting surface DS1a of a first optical microstructure MS1a on a side of the geometric center GC and farthest from the geometric center GC and the surface 101s of the transparent substrate 101 is different from an angle of a refracting angle θ1 between a refracting surface DS1b of a first optical microstructure MS1b on another side of the geometric center GC and farthest from the geometric center GC and the surface 101s of the transparent substrate 101. In the direction Y, an angle of a refracting angle α2 between a refracting surface DS2a of a second optical microstructure MS2a on a side of the geometric center GC and farthest from the geometric center GC and the surface 101s of the transparent substrate 101 is equal to an angle of a refracting angle θ2 between a refracting surface DS2b of a second optical microstructure MS2b on another of the geometric center GC and farthest from the geometric center GC and the surface 101s of the transparent substrate 101.

However, the disclosure is not limited thereto. In other embodiments, the respective angles of refracting angles of multiple second optical microstructures may be asymmetrically distributed along the direction Y with respect to the geometric center GC.

Since a structural angle β1 between a structural surface SS1a of the first optical microstructure MS1a and the surface 101s of the transparent substrate 101, a structural angle φ1 between a structural surface SS1b of the first optical microstructure MS1b and the surface 101s of the transparent substrate 101, a structural angle β2 between a structural surface SS2a of the second optical microstructure MS2a and the surface 101s of the transparent substrate 101, and a structural angle φ2 between a structural surface SS2b of the second optical microstructure MS2b and the surface 101s of the transparent substrate 101 of this embodiment are configured similarly to the structural angle β and the structural angle φ of the optical microstructure MS-A of the viewing angle control film 100A in FIG. 8 and the structural angle φ of the optical microstructure MS of the viewing angle control film 100 in FIG. 3, for detailed description, reference may be made to the relevant paragraphs of the embodiment mentioned above, and details will not be repeated here.

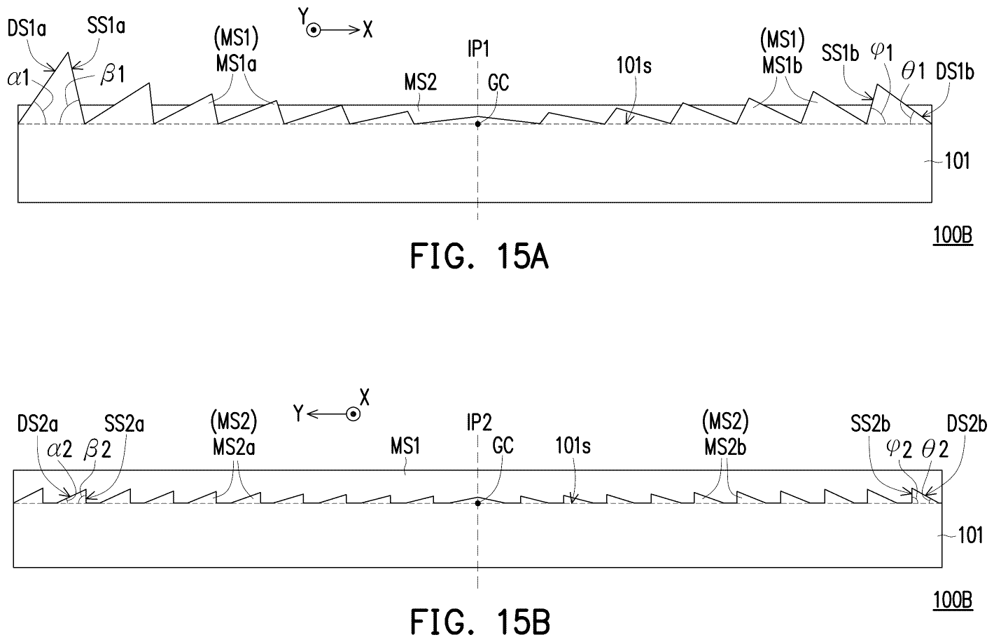

FIG. 16 is a schematic cross-sectional view of the viewing angle control film in FIG. 8 according to another variation embodiment. Please refer to FIG. 16. The difference between a viewing angle control film 100C of this embodiment and the viewing angle control film 100A in FIG. 8 is merely that the viewing angle control film 100C of this embodiment may also selectively include an optical auxiliary layer 150 disposed on a side surface 101s″ of the transparent substrate 101 away from the optical microstructure MS-A. For example, the optical auxiliary layer 150 may be a matt layer, an anti-glare (AG) layer, or a microstructure layer, but not limited thereto. By disposing the optical auxiliary layer 150, the concealment or visual effect of the display apparatus adopting the viewing angle control film 100C can be improved.

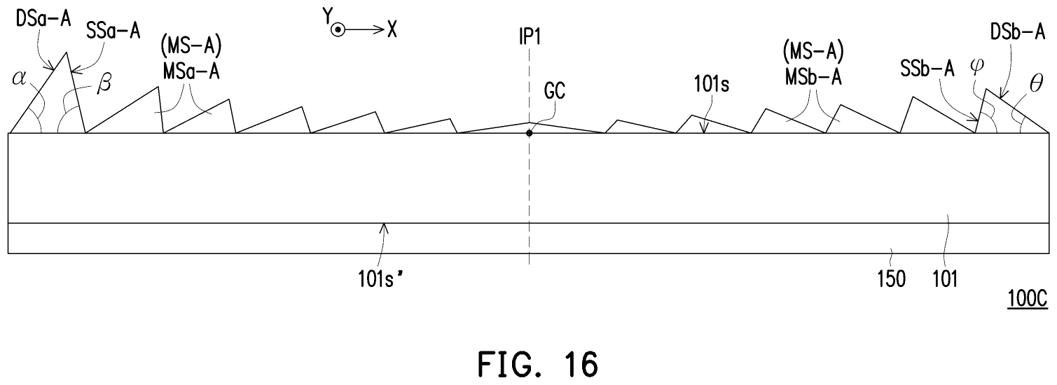

FIG. 17A and FIG. 17B are schematic top views of the viewing angle control film in FIG. 7 according to other variation embodiments. Different from the optical microstructures of the viewing angle control film 100A in FIG. 7, which are microstructures that extend to a side of the geometric center GC, in a viewing angle control film 100D of a variation embodiment, multiple optical microstructures MS-B may be disposed around the geometric center GC of the disposed range thereof, and the orthographic projection outline of each optical microstructure MS-B on the transparent substrate 101 is a rectangle (as shown in FIG. 17A), but is not limited thereto. In another variation embodiment of a viewing angle control film 100E, the orthographic projection outlines of multiple optical microstructures MS-C on the transparent substrate 101 may also be multiple concentric circles (as shown in FIG. 17B).

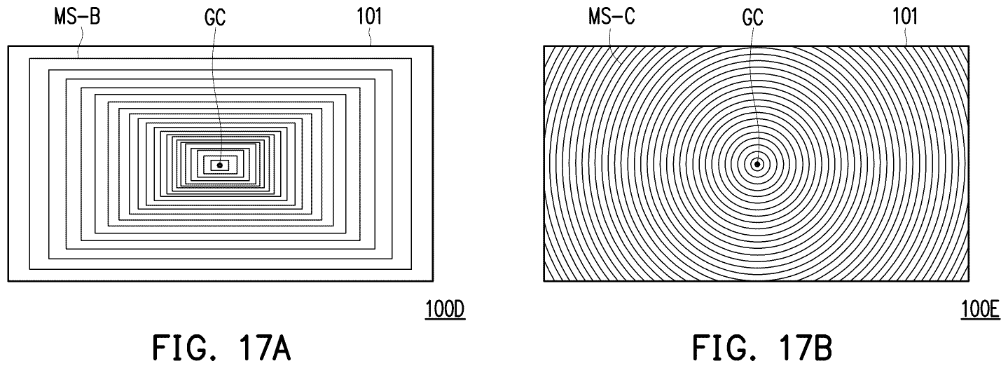

FIG. 18 is a schematic view of a display apparatus according to the third embodiment of the disclosure. Please refer to FIG. 18. The difference between a display apparatus 10B of this embodiment and the display apparatus 10 in FIG. 1 is merely that the disposed position of the viewing angle control film is different. Specifically, in the display apparatus 10B of this embodiment, the viewing angle control film 100 is disposed on a side of the display panel DP away from the backlight module BLU.

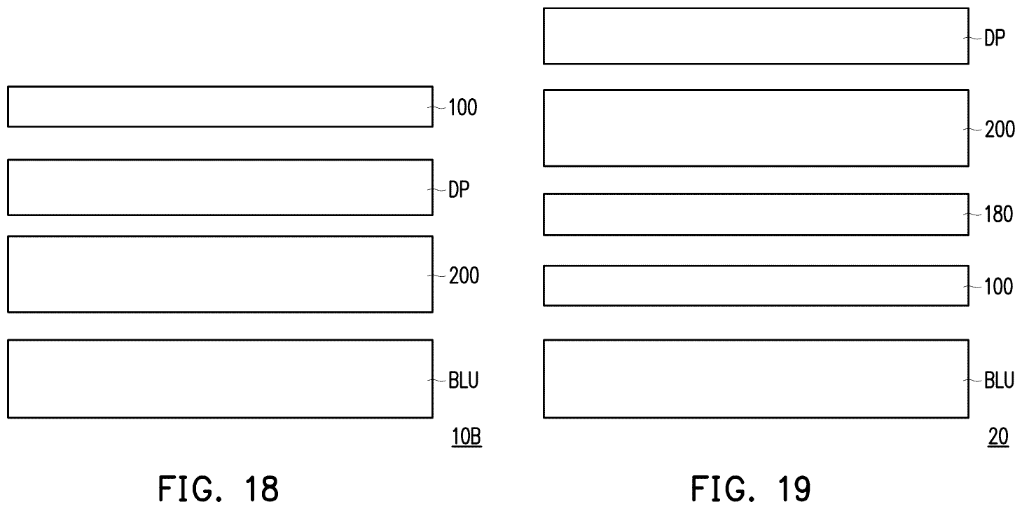

FIG. 19 is a schematic cross-sectional view of a display apparatus according to the fourth embodiment of the disclosure. Please refer to FIG. 19. The difference between a display apparatus 20 of this embodiment and the display apparatus 10 in FIG. 1 is that, the display apparatus 20 of this embodiment may also selectively include an anisotropic diffuser 180 disposed overlapping the viewing angle control film 100. In this embodiment, the anisotropic diffuser 180 may be disposed between the electrically controlled viewing angle switcher 200 and the viewing angle control film 100, but not limited thereto. In other embodies, the anisotropic diffuser 180 may also be disposed between the viewing angle control film 100 and the backlight module BLU.

For example, the anisotropic diffuser 180 merely has the scattering ability in the direction perpendicular to the privacy protection direction of the display apparatus 20 (i.e., the arrangement direction of the multiple optical microstructures MS of the viewing angle control film 100 in FIG. 3). Therefore, whilst improving the sharing visual effect of the display apparatus 20 when operating in the sharing mode, and the deterioration of the privacy protection effect of the display apparatus 20 when operating in the privacy protection mode can also be prevented.

In summary, in the viewing angle control film of an embodiment of the disclosure, multiple first optical microstructures each has a refracting surface on the side away from the geometric center of the disposed range thereof, and the first refracting angles included between the respective angles of refracting surfaces of the first optical microstructures and the surface of the transparent substrate are asymmetrically distributed with respect to the geometric center. Through such a disposition, the light may be guided to the specific light-collecting position after passing through different positions of the viewing angle control film, thereby improving the uniformity of the overall light emission brightness at the specific position. Therefore, the display apparatus disposed with the viewing angle control film can have a good brightness uniformity on the display screen at the specific viewing position.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A viewing angle control film, comprising:
a transparent substrate; and
a plurality of first optical microstructures disposed on a surface of the transparent substrate, wherein a disposed range of the plurality of first optical microstructures has a geometric center, each of the plurality of first optical microstructures has a first refracting surface away from the geometric center, and first refracting angles included between the first refracting surfaces of the plurality of first optical microstructures respectively and the surface of the transparent substrate are asymmetrically distributed with respect to the geometric center.

2. The viewing angle control film as claimed in claim 1, wherein the first refracting angles included between the first refracting surfaces of the plurality of first optical microstructures respectively and the surface of the transparent substrate gradually decrease as approaching the geometric center.

3. The viewing angle control film as claimed in claim 1, wherein the plurality of first optical microstructures comprise two first optical microstructures symmetrically disposed with respect to the geometric center, and first refracting angles included between the first refracting surfaces of the two first optical microstructures respectively and the surface of the transparent substrate are not the same.

4. The viewing angle control film as claimed in claim 1, wherein the plurality of first optical microstructures comprise two first optical microstructures respectively disposed on opposite sides of the geometric center and farthest from the geometric center, and first refracting angles included between the first refracting surfaces of the two first optical microstructures respectively and the surface of the transparent substrate are not the same.

5. The viewing angle control film as claimed in claim 1, wherein the each of the plurality of first optical microstructures also has a structural surface facing the geometric center, and a first structural angle included between the structural surface and the surface of the transparent substrate is greater than or equal to the first refracting angle.

6. The viewing angle control film as claimed in claim 5, wherein the first structural angles included between the structural surfaces of the plurality of first optical microstructures and the surface of the transparent substrate gradually decrease as approaching the geometric center.

7. The viewing angle control film as claimed in claim 1, wherein angles of the first refracting angles asymmetrically distributed has a minimum value at a position, the first refracting angles included between the first refracting surfaces of the plurality of first optical microstructures and the surface of the transparent substrate gradually decrease as approaching the position, and the position does not overlap the geometric center.

8. The viewing angle control film as claimed in claim 1, further comprising:
a plurality of second optical microstructures disposed on the surface of the transparent substrate, wherein a disposed range of the plurality of second optical microstructures overlaps the disposed range of the plurality of first optical microstructures, and an extending direction of the plurality of first optical microstructures intersects with an extending direction of the plurality of second optical microstructures.

9. The viewing angle control film as claimed in claim 8, wherein each of the plurality of second optical microstructures has a second refracting surface away from the geometric center, and second refracting angles included between the second refracting surfaces of the plurality of second optical microstructures respectively and the surface of the transparent substrate are symmetrically distributed or asymmetrically distributed with respect to the geometric center.

10. The viewing angle control film as claimed in claim 1, wherein the plurality of first optical microstructures are disposed around the geometric center.

11. The viewing angle control film as claimed in claim 1, wherein an optical auxiliary layer is disposed on a side surface of the transparent substrate away from the plurality of first optical microstructures.

12. A display apparatus, comprising:
a viewing angle control film, comprising:
a transparent substrate; and
a plurality of first optical microstructures disposed on a surface of the transparent substrate, wherein a disposed range of the plurality of first optical microstructures has a geometric center, each of the plurality of first optical microstructures has a first refracting surface away from the geometric center, and first refracting angles included between the first refracting surfaces of the plurality of first optical microstructures respectively and the surface of the transparent substrate are asymmetrically distributed with respect to the geometric center; and
a display panel disposed on a side of the viewing angle control film.

13. The display apparatus as claimed in claim 12, further comprising:
an electrically controlled viewing angle switcher overlapping the viewing angle control film and the display panel.

14. The display apparatus as claimed in claim 12, further comprising:
an anisotropic diffuser overlapping the viewing angle control film.
